(19) United States
(12) Patent Application Publication
(10) Pub. No.: US 2014/0074383 A1
(43) Pub. Date: Mar. 13, 2014

(54) On-Vehicle Carbon Monoxide Detector

(71) Applicant: Maxwell Everett Frey, Englewood, CO (US)

(72) Inventor: Maxwell Everett Frey, Englewood, CO (US)

(21) Appl. No.: 13/612,245

(22) Filed: Sep. 12, 2012

(51) Int. Cl. F02D 41/22; F02D 41/10

(52) U.S. Cl. 701/110; 701/101; 701/112

(57) ABSTRACT

An on-vehicle carbon monoxide detector is provided where the detector has an on-board diagnostic, 16-pin connector which interfaces the carbon monoxide detector with a vehicle's computer system. This interface allows the detector to be installed on any vehicle with a 16-pin connector and provide functionality when the carbon monoxide content of air exceeds a predetermined level. With an interface with a vehicle's computer system, the present disclosure may warn an occupant with many different signals, or combination of signals. Examples include visual signals and audible signals. Further, the present disclosure provides a system for altering the performance of the vehicle if an occupant is unresponsive.

### FIELD OF THE INVENTION

The present application relates to the field of carbon monoxide detection and vehicle enhancements.

### BACKGROUND OF THE INVENTION

Carbon monoxide is poisonous to humans, and many modern processes have the potential to produce lethal amounts of carbon monoxide in homes and vehicles. The CDC estimates that an average of 500 people die per year as a result of unintentional carbon monoxide poisoning. CDC, MORBIDITY AND MORTALITY WEEKLY REPORT, Dec. 21, 2007 available at www.cdc.gov/mmwr/preview/mmwrthml/mm5650a1.htm. In 2010, a Colorado woman, Ashley Fritz, died as a result of running a vehicle in a closed garage. She intended to charge her cell phone and only ran the vehicle for a short period of time, but she succumbed to the carbon monoxide. Henrietta Masloff, Invisible Carbon Monoxide Can Kill before You Know What's Happening, THE DENVER POST, Apr. 16, 2012 available at www.denverpost.com/outwest/ci_{—}20397588/invisible-carbon-monoxide-can-kill-before-you-know.

Stories of carbon monoxide poisoning are frequently associated with vehicles left running in garages, but new vehicle technologies may add more pitfalls. For example, a New York man allegedly died due to a keyless ignition system on his vehicle. John Marzulli, Toyota Sued in Carbon Monoxide Tragedy that Killed 79-year-old Lawyer, DAILY NEWS, Nov. 7, 2010 [available at articles/nydailynews.com/2010-11-07/news/27080564_{—}1_carbon-monoxide-death-carbon-monoxide-keyless-ignition]. The man parked his vehicle in his attached garage, and he exited the vehicle without realizing the vehicle's engine was still running. The vehicle produced enough carbon monoxide to kill the man while he was inside of his house.

Carbon monoxide detectors are beginning to be used in modern homes. These in-home detectors are usually battery-operated or occasionally plugged into a wall socket. These prior art detectors are very basic and will send an audible signal from the device itself once the carbon monoxide content of air exceeds a predetermined level.

Beyond these common carbon monoxide detectors, some carbon monoxide detectors have enhanced functionality or are designed for specialized applications. For example, U.S. Pat. No. 6,339,379, which is hereby incorporated by reference in its entirety, discloses a carbon monoxide detector for sensing carbon monoxide in a furnace intake duct. Here, a housing is attached to the exterior of the furnace intake duct, and the detector has a probe which extends into the intake duct. The carbon monoxide detector's control unit is in communication with the furnace's limiting switch. Therefore, when the carbon monoxide detector senses that the carbon monoxide content of air has exceeded a predetermined level, the detector may send a communiqué to the furnace's limiting switch to shut down the furnace.

Another carbon monoxide detector has similar functionality as the detector in the '379 patent, but this detector functions in a car garage. U.S. Pat. No. 7,183,933, which is hereby incorporated by reference in its entirety, discloses a garage monitoring system which includes a carbon monoxide detector. When the carbon monoxide detector senses that the carbon monoxide content of air has exceeded a predetermined level, the detector emits an audible signal. The garage monitoring system senses this audible signal and adjusts the position of the garage door to an open position. Presumably, this allows any carbon monoxide in the garage to vent out of the now-open garage door.

While the '993 patent is incidentally relevant to vehicles, other carbon monoxide detectors are known which are associated with vehicles. U.S. Pat. No. 3,502,887, which is hereby incorporated by reference in its entirety, discloses an aftermarket carbon monoxide detector for a vehicle which plugs into a vehicle's cigarette lighter socket. Here, the detector itself provides an audible or visual signal to the vehicle's occupant when the carbon monoxide content of air exceeds a predetermined level. While this detector easily interfaces with a vehicle via a cigarette lighter socket, this invention is a basic, passive carbon monoxide detector which has been adapted for a vehicle's power source. There is no functionality or integration with the vehicle beyond receiving power from the vehicle and producing a simple signal.

Another carbon monoxide detector for vehicles is disclosed in U.S. Pat. No. 5,739,756, which is hereby incorporated by reference in its entirety. This aftermarket carbon monoxide detector is mounted at the highest point inside of a passenger area to detect carbon monoxide (which is lighter than air). However, this detector necessitates a substantial installation process and is not something a typical user could install or operate. First, the detector must be mounted to the ceiling of the passenger area with screws. Second, a cable must be run to the dashboard of the vehicle and interconnected to a light on the dashboard. Also, like the '887 patent, this detector is passive and basic since it emits a simple signal when the carbon monoxide content of air exceeds a predetermined level. There is no functionality beyond a simple signal or integration with the vehicle's on-board diagnostic system.

### SUMMARY OF THE INVENTION

It is the object of the present disclosure to provide an on-vehicle carbon monoxide detector which easily interfaces with a vehicle and provides functionality beyond a simple signal. Unlike the prior art, the present disclosure may be in the form of an aftermarket product as well as an OEM-installed product.

In one embodiment of the present disclosure, a carbon monoxide detector has an on-board diagnostic (“OBD”), 16-pin connector. The 16-pin connector allows the carbon monoxide detector to interface with a vehicle's computer system such that a computing module in the carbon monoxide detector may dictate instructions to the vehicle's computer system. Through these instructions, the present disclosure may utilize various components of a vehicle to signal the vehicle's occupants or alter the performance of the vehicle.

When some embodiments of the present disclosure determine that the carbon monoxide content of air has exceeded a predetermined level, then it may signal an operator of a vehicle, and the signal may take many forms. The carbon monoxide detector's computing module may instruct the vehicle's computer system to signal the vehicle's occupants with a light or visual signal. Similarly, an audible signal may be employed. Further, a person who is skilled in the art may appreciate that the wide array of signals that components of a vehicle may produce may be combined in concert to provide a better signal to a vehicle's occupants.

The above-mentioned signals may provide a signal to a vehicle's occupant when the occupant is unaware that the carbon monoxide content of air is dangerous. However, in other instances the introduction of carbon monoxide into a vehicle may be intentional.

In one embodiment of the present disclosure, a computing module in a carbon monoxide detector may instruct a vehicle's computing system to shut the vehicle off if the vehicle is stationary. This instruction will prevent the vehicle from generating additional carbon monoxide.

Additionally, the present disclosure may alter the performance of a vehicle while the vehicle is not stationary. By way of example but not limitation, the present disclosure may roll down the windows to vent the interior of the vehicle. Further, the present disclosure may communicate with a vehicle's computing system, which may take a series of steps to stop the vehicle and prevent the vehicle from producing additional carbon monoxide. First, a carbon monoxide detector may sense when the carbon monoxide content of air exceeds a predetermined level and, secondly, signal the vehicle's occupants. If there is no timely response made by the operator of the vehicle, a third step could be to alter the performance of the vehicle.

A person who is skilled in the art will appreciate that the performance of a vehicle may be altered by preventing further acceleration and/or cutting the gas pedal inputs to the vehicle's engine and/or applying a break to permanently stop. This step will decrease the vehicle's speed while preserving power steering. A final step would be to shut the vehicle off once it has either reached a reasonably slow speed or stopped.

These and other features will be understood after reviewing the Detailed Description and Drawing Figures attached hereto.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

In the drawings:

FIG. 1 shows a side elevation view of one embodiment of the present disclosure where a sensing module is interconnected to a computing module;

FIG. 2 shows an isometric view of one embodiment of the present disclosure where the device has an OBD, 16-pin connector;

FIG. 3 is an isometric view of one embodiment of the present disclosure where carbon monoxide enters a housing through a plurality of holes; and

FIG. 4 is an isometric view of one embodiment of the present disclosure where the carbon monoxide detector is interfaced with a computer system.

### DETAILED DESCRIPTION

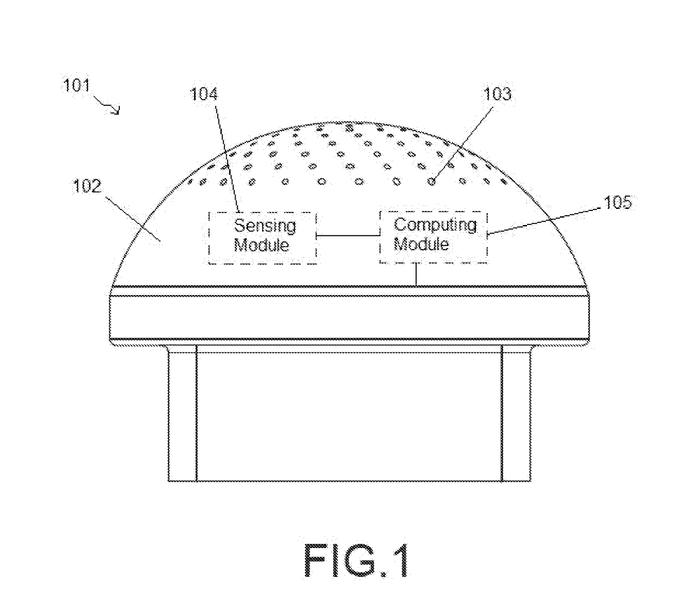

Various embodiments of the present disclosure include a sensing module, a computing module, and/or an OBD, 16-pin connector. FIG. 1 shows a side view of one embodiment of the present disclosure where internal components are visible. The carbon monoxide detector 101 has a housing 102 with a plurality of holes 103 in the housing 102. The holes 103 in the housing 102 allow internal components within the housing 102 to sense and sample exterior air.

In one embodiment of the present disclosure, the internal components in the housing 102 are a sensing module 104 and a computing module 105. The sensing module 104 may sense gases which are poisonous to humans, including carbon monoxide. The sensing module 104 may be interconnected to a computing module 105. This computing module 105 may serve to effectuate a protocol after the sensing module 104 has detected the carbon monoxide content of air which exceeds a predetermined level. Via its connection to an OBD, 16-pin connector, the computing module 105 may dictate instructions to a vehicle's computer system. Then, the vehicle's computer system may provide a signal to the vehicle's occupant, alerting him or her to a dangerous carbon monoxide content of air. The signal may be visual or auditory in nature. Further, a person who is skilled in the art will appreciate that different combinations of these signals may better alert a vehicle's occupant to a dangerous carbon monoxide content of air.

For example, the present disclosure may turn on the vehicle's headlights or, if the headlights are already on, turn the bright headlights on, either permanently or intermittently. The present disclosure may also turn on interior lights, such as a dome light, to signal the passenger. Also, the light signal does not have to be simply turning a light on, which a vehicle operator may overlook. A sequence of lighting signals may better alert the vehicle operator to danger.

Beyond visual signals, the present disclosure may also use auditory signals to alert a vehicle operator to danger. For example, the present disclosure may use the horn to signal the vehicle operator. Also, the present disclosure may utilize auditory signals from a radio, CD player, mp3 player, or a device connected to the vehicle's auxiliary cable to alert the vehicle operator to a potential danger. Further, various auditory signals on a vehicle may be coordinated in concert with each other to alert a vehicle operator.

Another auditory signal could be interactive in nature. An emergency system, such as On-Star, could receive a message from the present disclosure that the carbon monoxide content of the air is too high inside the vehicle. Then, an On-Star operator could contact the vehicle's communication system and/or verbally prompt the driver of the vehicle and instruct him or her to take a proper course of action to avoid poisonous levels of carbon monoxide.

With the advent of modern in-dash GPS systems and touch screens, these in-dash devices may present an additional avenue to alert a vehicle operator. These devices represent a combination of visual and auditory signals which may be more effective than either signal by itself. For example, an in-dash screen could present a simple message that the carbon monoxide content of air in the vehicle is dangerous. This message may coordinate with a pre-recorded audible warning or with the aforementioned On-Star-like emergency service. In this vein, any of the aforementioned visual or auditory signals may be used in concert with each other to present a more effective alert.

The aforementioned embodiments and methods to signal a vehicle operator are directed to an occupant who is unaware that carbon monoxide is a threat to their well-being. The following embodiments of the present disclosure are geared towards the vehicle operator who is attempting to harm himself or herself.

In one embodiment, if a vehicle is stationary, and the present disclosure is detecting a dangerous carbon monoxide content of air, then the present disclosure may turn off the engine of the vehicle to prevent the release of additional carbon monoxide gas. While this is relatively straight forward, there may also be scenarios where the vehicle is not stationary.

In another embodiment of the present disclosure, if a vehicle is in drive (in gear), and the present disclosure detects a dangerous carbon monoxide content of air, then the present disclosure may vent the interior of a vehicle by rolling down its windows. As an extreme measure, the present disclosure could employ a sequence of events to safely bring the vehicle operator to a stop and prevent the release of additional carbon monoxide.

A first step would be the initial sensing of a dangerous carbon monoxide content of air. Then a second step would signal the vehicle operator. This signal would largely be comprised of the aforementioned visual or auditory methods of alerting an occupant.

If a predetermined amount of time has elapsed, and there is no response from an occupant to reduce the concentration of carbon monoxide in the vehicle, then the present disclosure may vent the interior of the vehicle. In one embodiment, the present disclosure may instruct the vehicle's computer system to roll down one or all of a vehicle's windows in order to release the carbon monoxide-saturated air and introduce fresh exterior air.

Even if this step does not work, the present disclosure has the capability to take the extreme measure of slowing down a vehicle and shutting off its engine. For example, the further step may be to prevent the vehicle from further accelerating which would eventually force a driver to pull over. Alternatively, the present disclosure could prevent all gas pedal inputs from the vehicle operator and force the driver to pull over even more quickly. The third step would require the engine to continue running such that power steering is preserved for the vehicle operator.

Another step would be to turn off the engine of the vehicle to prevent the release of carbon monoxide altogether. This is a final step and would be dangerous since the vehicle is in motion. The present disclosure may withhold employing this final step until the vehicle is under a threshold speed to make the engine shut off as safe as possible.

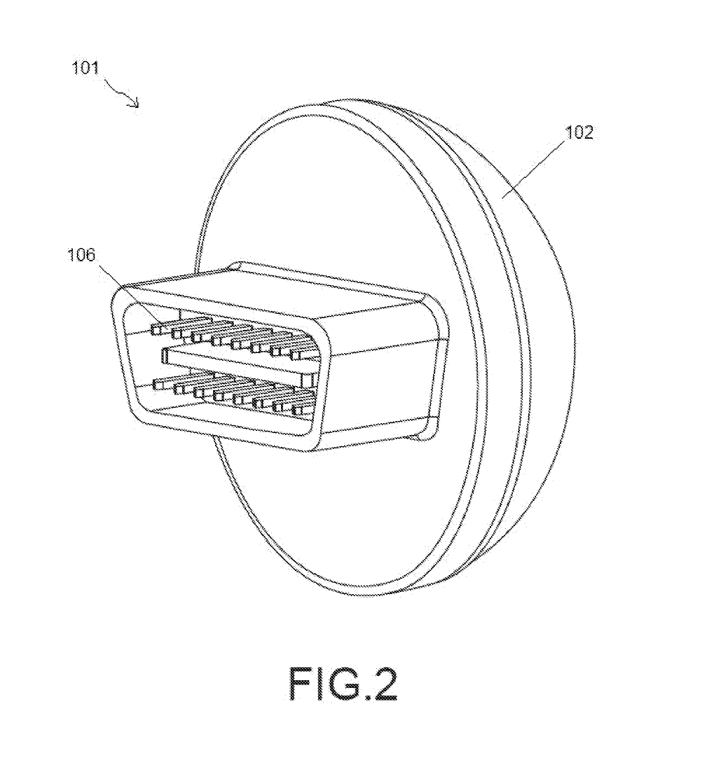

FIG. 2 shows an isometric view of one embodiment of the present disclosure where the backside of the carbon monoxide detector 101 has an interface with a vehicle's computer. In this embodiment, the interface is an OBD, 16-pin connector 106. The OBD, 16-pin connector 106 allows the computing module 105 to communicate with a vehicle's computer system and dictate instructions to the system. These instructions allow the present disclosure to control a vehicle's components to either send a signal to an occupant or alter the performance of the vehicle.

Here, the OBD, 16-pin connector 106 extends away from the housing 102 such that the carbon monoxide detector 101 of present disclosure may be readily used on any vehicle which accepts such an OBD, 16-pin connection 106. Therefore, the benefits of this disclosure may be realized on a wide range of vehicles, both past and present.

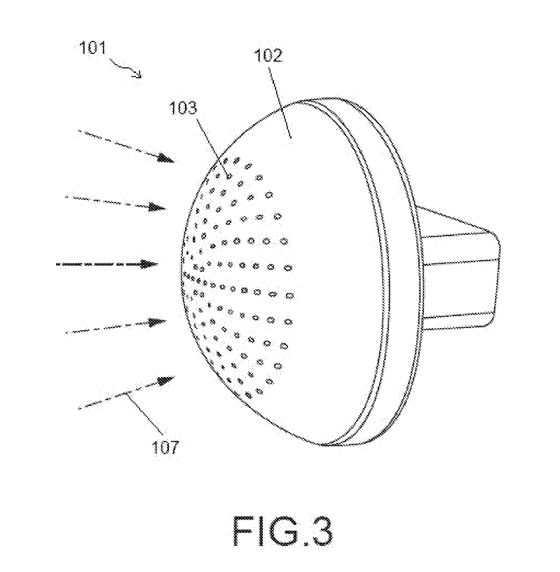

FIG. 3 shows an isometric view of one embodiment of the present disclosure where sample air 107 filters into the housing 102 of the carbon monoxide detector 101 through a plurality of holes 103. It would be advantageous to have the plurality of holes 103 present a large area on the housing 102 for the sample air 107 to filter through, but not large enough to threaten the structural integrity of the housing 102 or harm the internal components of the carbon monoxide detector 101.

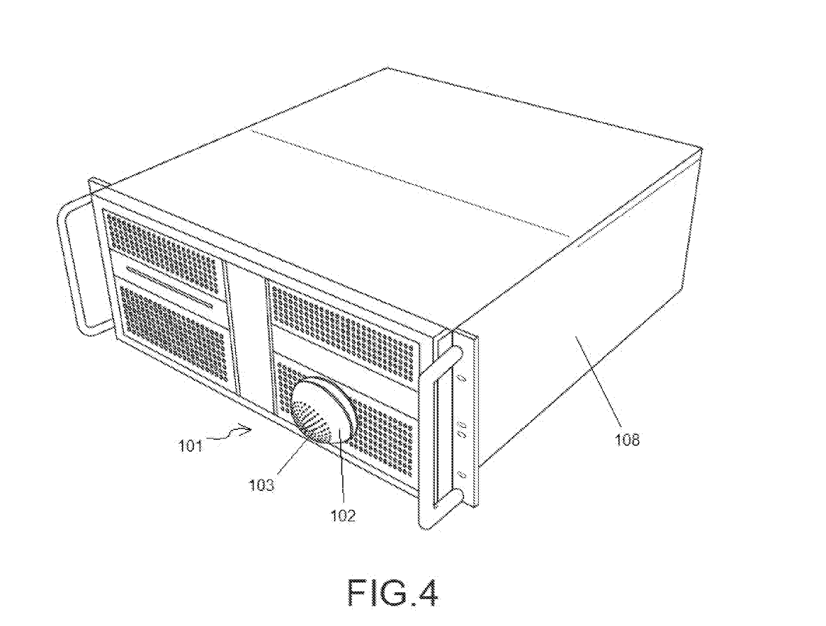

FIG. 4 shows an isometric view of one embodiment of the present disclosure where the carbon monoxide detector 101 is interfaced with a computer system 108. Through a computer system 102 the computing module 105 of the present disclosure may dictate instructions to a vehicle to provide a signal to the vehicle or to alter the vehicle's performance.

The foregoing description of the present disclosure has been presented for illustration and description purposes. However, the description is not intended to limit the invention to only the forms disclosed herein. In the foregoing Detailed Description for example, various features are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Consequently, variations and modifications commensurate with the above teachings and skill and knowledge of the relevant art are within the scope of the present invention. The embodiments described herein above are further intended to explain best modes of practicing the invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

What is claimed is:

1. A system for detecting carbon monoxide, comprising:
a sensing module for detecting the carbon monoxide content of air;
a computing module interconnected to the sensing module such that the sensing module may communicate to the computing module;
an interface interconnected to the computing module, allowing the computing module to communicate with a vehicle's on-board diagnostic computer; and
a housing to contain the sensing module and computing module, wherein the housing is configured to allow the sensing module to sample air outside of the housing, and wherein the housing is configured to allow the interface to selectively interconnect to the vehicle's on-board diagnostic computer.

2. The system in claim 1, wherein the interface is a 16-pin connector.

3. The system in claim 1, wherein the computing module is configured to send an instruction to the vehicle's on-board diagnostic computer when the carbon monoxide content of air exceeds a predetermined level, wherein the on-board diagnostic computer turns on one or more of the vehicle's lights to provide a visual signal.

4. The system in claim 1, wherein the computing module is configured to send an instruction to the vehicle's on-board diagnostic computer when the carbon monoxide content of air exceeds a predetermined level, wherein the on-board diagnostic computer turns on the vehicle's bright lights to provide a visual signal.

5. The system in claim 1, wherein the computing module is configured to send an instruction to the vehicle's on-board diagnostic computer when the carbon monoxide content of air exceeds a predetermined level, wherein the on-board diagnostic computer turns on the vehicle's dome light to provide a visual signal.

6. The system in claim 1, wherein the computing module is configured to send an instruction to the vehicle's on-board diagnostic computer when the carbon monoxide content of air exceeds a predetermined level, wherein the on-board diagnostic computer turns on the vehicle's horn to provide an audible signal.

7. The system in claim 1, wherein the computing module is configured to send an instruction to the vehicle's on-board diagnostic computer when the carbon monoxide content of air exceeds a predetermined level, wherein the on-board diagnostic computer turns on the vehicle's stereo system to provide an audible signal.

8. The system in claim 1, wherein the computing module is configured to send an instruction to the vehicle's on-board diagnostic computer when the carbon monoxide content of air exceeds a predetermined level, wherein the on-board diagnostic computer alerts an emergency services operator to provide an interactive audible signal.

9. The system in claim 1, wherein the computing module is configured to send an instruction to the vehicle's on-board diagnostic computer when the carbon monoxide content of air exceeds a predetermined level, wherein the on-board diagnostic computer uses the vehicle's in-dash screen to provide at least one of an audible and a visual signal.

10. A system for communicating with a vehicle, comprising:
a sensing module for detecting the carbon monoxide content of air;
a computing module interconnected to the sensing module such that the sensing module may communicate to the computing module when the carbon monoxide content of air exceeds a predetermined level;
an interface interconnected to the computing module, allowing the computing module to communicate with a vehicle's on-board diagnostic computer; and
a housing to contain the sensing module and computing module, wherein the housing has holes configured to allow the sensing module to sample air outside of the housing, and wherein the housing is configured to allow the interface to selectively interconnect to the vehicle's on-board diagnostic computer.

11. The system in claim 10, wherein the computing module is configured to send an instruction to the vehicle's on-board diagnostic computer when the carbon monoxide content of air exceeds a predetermined level, wherein the vehicle is stationary and the on-board diagnostic computer turns off the vehicle's engine or power supply.

12. The system in claim 10, wherein the computing module is configured to send an instruction to the vehicle's on-board diagnostic computer when the carbon monoxide content of air exceeds a predetermined level, wherein the on-board diagnostic computer opens one or more of the vehicle's windows to vent the interior of the vehicle.

13. The system in claim 10, wherein the computing module is configured to send an instruction to the vehicle's on-board diagnostic computer when the carbon monoxide content of air exceeds a predetermined level, wherein the on-board diagnostic computer prevents the vehicle from further accelerating.

14. The system in claim 10, wherein the computing module is configured to send an instruction to the vehicle's on-board diagnostic computer when the carbon monoxide content of air exceeds a predetermined level, wherein the on-board diagnostic computer prevents input from the vehicle's acceleration pedal.

15. The system in claim 14, wherein the computing module is configured to send an instruction to the vehicle's on-board diagnostic computer when the carbon monoxide content of air exceeds a predetermined level, wherein the on-board diagnostic computer turns off the vehicle's engine or power supply once the vehicle's rate of speed is below a predetermined level.
